(19) United States
(12) Patent Application Publication
(10) Pub. No.: US 2011/0034178 A1
(43) Pub. Date: Feb. 10, 2011

(54) SYSTEMS AND METHODS FOR GENERATING A LOCATION OF A MOBILE DEVICE USING CELL SECTOR INFORMATION

(76) Inventor: Chand MEHTA, Santa Clara, CA (US)

Correspondence Address: QUALCOMM INCORPORATED, 5775 MOREHOUSE DR., SAN DIEGO, CA, 92121, US

(21) Appl. No.: 12/538,142

(22) Filed: Aug. 9, 2009

(51) Int. Cl. H04W 4/02

(52) U.S. Cl. 455/456.1

(57) ABSTRACT

Systems and methods for generating a location of a mobile device using cell sector data are provided. A mobile device is in service connection with a base station, which has a corresponding service area. Upon entering the service area of another base station, the mobile device enters service connection with the second base station in a handoff event. The mobile device and/or the base station determines the location of each of the base stations, and estimates the approximate location of the mobile device based on the locations of the base stations. In one or more implementations, the estimated position can comprise a midpoint of a line joining the two base stations. The systems and methods can be implemented with a random location generator to improve accuracy. The approximate location of the mobile device can be inputted into a GPS-enabled device to reduce times to first fix.

### BACKGROUND

This present teachings generally relate to systems and methods for generating an estimated location of a mobile device using cell sector position data.

Cellular handset technology is continuously advancing to allow more features for mobile users. Mobile devices or handsets can incorporate location-based services which can help identify a location of the device. Location-based services can enable parcel and vehicle tracking services, personalized weather services, location-based games, social networking, and/or other services.

Some mobile devices rely upon the location of an associated base station to generate an approximate position for the device, particularly for devices that do not incorporate Global Positioning System (GPS) capability. Mobile devices that rely upon base station coordinates can perform signal triangulation and/or Trilateration among three base stations to generate an estimated current position. The mobile device, however, can require frequent two-way overhead with the three base stations to determine its approximate location when using the triangulation and/or Trilateration techniques.

In other known implementations, the location of a mobile device can be estimated based on the coordinates of a single base station with which the mobile device is communicating. The coverage range of a given base station can be estimated, and the location of the mobile device can be determined to be within that coverage zone. The use of a single base station to locate the mobile device within that area leads to a comparatively unrefined location estimate, which can be on the order of an approximately circular range of a 5-10 mile radius, or another comparatively unrefined range.

A need therefore exists for more accurate and less expensive systems and methods for determining the location of a mobile device in the absence of GPS capability. Further, a need exists to reduce the position calculation time and the amount of communication between the mobile device and the base stations. Moreover, a need exists for the systems and methods to adjust an estimated location after subsequent calculations to provide a more accurate location.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to the present teachings in one or more aspects, systems and methods for determining a location of a mobile device or other handset are provided. According to one or more implementations in one regard, a first base station and a second base station each have independent geographic locations and corresponding cell sectors, or service or coverage areas. In operation, a service connection of the mobile device can change service areas, or be handed off, from the first base station to the second base station. Platforms and techniques according to various implementations of the present teachings can estimate the location of the mobile device based on the locations of the first base station and the second base station, and the occurrence of the handoff event between those two stations. The estimated location of the mobile device can be transmitted to the device itself through control signaling. One or more implementations further relate to systems and methods for determining a mobile device location through the geometric relationship between base station locations, once handoff events localize the service area in which a mobile device is entering.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated in and constitute a part of this specification, illustrate implementations of the present disclosure and together with the description, serve to explain the implementations.

FIG. 1 illustrates a functional block diagram of an exemplary wireless network, according to one aspect.

FIG. 2 illustrates an exemplary hardware configuration of a mobile device, according to one aspect.

FIG. 3 illustrates an exemplary hardware configuration of a base station, according to one aspect.

FIG. 4 is a diagram illustrating an exemplary relationship between service areas, according to one aspect.

FIG. 5 is a diagram illustrating an implementation of an estimation of an approximate location of a mobile device, according to one aspect.

FIG. 6 is a diagram illustrating an implementation of an estimation of an approximate location of a mobile device, according to one aspect.

FIG. 7 is a flow diagram illustrating a process of estimating the location of a mobile device at a base station, according to one aspect.

FIG. 8 is a flow diagram illustrating a process of estimating the location of a mobile device at the mobile device, according to one aspect.

### DETAILED DESCRIPTION

According to the present teachings in one or more aspects, systems and methods for generating a location of a mobile device using cell sector data provided by a base station of the serving cell, including position and identification information of the base station, are provided. The systems and methods can improve the accuracy of a location fix of a mobile device within a service or coverage area, cell sector, or the like by narrowing the estimated location to a projected roaming path of the mobile device, as it departs base station service area and enters another. Systems, methods, and apparatus according to the present teachings can be implemented as software or hardware on new or existing mobile devices, and/or on new or existing base stations.

In the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Mobile devices or handsets as described herein can be understood to be cellular phones, laptops, PDAs, mobile messaging devices, or other devices capable of mobile or wireless communication. The mobile devices can be in communication with a base station via, for example, a cellular or wireless connection, and the corresponding service area can be the serving cell sector. Base stations can be deployed in a geographic array, and each base station can include a service area in which the base station can connect with a mobile device. Each base station can maintain service with one or more mobile devices throughout the service area of the base station. The service areas of the base stations can collectively provide service to mobile devices throughout an area in which mobile devices can roam, travel, navigate, and the like. A mobile device can change service areas, or enter into a handoff event, as the mobile device roams throughout a region. The service areas of individual base stations can overlap, so as to reduce the chances that certain areas may lack service (dead zones). Further, overlapping service areas can reduce the occurrence of mobile devices losing service while in motion, particularly at higher speeds.

When a mobile device is registered and receiving a service connection with a base station, the geographic location of the base station can be registered or stored to the mobile device, as well as within the base station itself. The mobile device can determine the location of the base station to which it is connected by utilizing a known embedded API such as, for example, “GetSectorInfo( ),” as used by, for example, BREW® platform of QUALCOMM Incorporated, which returns the latitude and longitude coordinates of the base station to the calling application. In one or more implementations such as, for example, CDMA channel access, the location of the base station can be transmitted using a “SystemInformation” message. In one or more aspects, the base station can transmit its location to the mobile device in an encoded message that the mobile device can subsequently decode.

The mobile device can change serving cell sectors during a handoff event. A handoff event can occur when the mobile device is in motion such as, for example, when the user of the mobile device is driving a car, walking, riding a bike, or otherwise roaming in some way. During the handoff event, the mobile device and/or base station can determine or be notified that a handoff event transferring the mobile device from the control of one service area to another has taken place. The mobile device can determine and store the location of the new base station after a handoff occurs. Present implementations can improve the accuracy of location services and functions of mobile devices after such handoff events occur, in one regard using knowledge of the locations of the respective base stations to deduce a likely entry path or zone into the second service area.

After a handoff event, either the mobile device or base station can approximate the location of the mobile device by using the location of the preceding base station to which the mobile device was previously connected, and the location of the base station to which the mobile device is currently connected. One or more implementations described herein can refer to the mobile device as performing the approximation calculations. However, it will be appreciated that any calculating, approximating, registering, storing, and/or the like associated with the implementations described herein can be performed by a mobile device, by one or more base stations, or by servers or other entities or logic capable of receiving data within the network.

The mobile device can, according to one or more implementations, estimate its own approximate location by constructing a connecting line between the locations of the previous base station and the current base station, along which line the device's immediate location is estimated to lie. In one or more implementations, accuracy compared to estimates based on entire cell sector areas can be improved over a variety of user conditions, including, for example, users moving at comparatively moderate speeds of 20 mph-40 mph, or other ranges. However, it is understood that the systems and methods of the current implementations can estimate the location of the mobile device when the mobile device is moving at a variety of different speeds.

Reference will now be made in detail to exemplary implementations of the disclosure, an example of which is illustrated in the accompanying drawings. Wherever possible, the same reference names and numbers will be used throughout the drawings to refer to the same or like parts.

In the following description, reference is made to the accompanying drawings that form a part thereof, and in which is shown by way of illustration-specific exemplary implementations. These implementations are described in sufficient detail to enable those skilled in the art to practice the implementations, and it is to be understood that other implementations can be used and that changes can be made without departing from the scope of this disclosure. The following description is, therefore, merely exemplary.

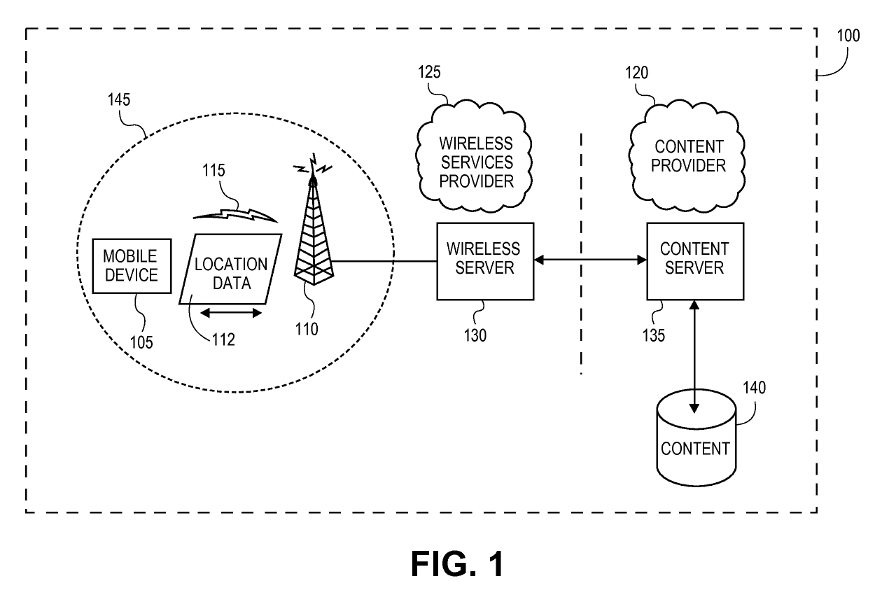

FIG. 1 illustrates a block diagram of an exemplary wireless network 100 consistent with one or more implementations, according to one aspect. As shown in FIG. 1, wireless network 100 can include a wireless services provider 125 and a content provider 120. Wireless services provider 125 can provide cellular telephony or other digital communications services to users of mobile electronic devices, such as a mobile device 105. In one or more implementations, mobile device 105 can be a cellular phone, a laptop, a PDA, or a mobile messaging device. Wireless services provider 125 may be a cellular telephone service provider, a personal communications services (PCS) provider, or a provider of other wireless services. Wireless services provider 125 may operate a wireless server 130 and a set of base stations 110. As shown in FIG. 1, mobile device 105 may communicate with wireless server 130 using a client-server software architecture over a wireless interface 115 through a set of base stations 110. Mobile device 105, wireless interface 115, and set of base stations 110 can together comprise a wireless communication network 145 consistent with various implementations described herein.

Set of base stations 110 can be configured to provide communication service within a service area. As used herein, a “service area” can be any zone, boundary, or other area within which set of base stations 110 can establish communications service with mobile device 105. The service area supported or established by set of base stations 110 can be of any regular or irregular shape. In one or more implementations, the service area can be of generally fixed size or area, or can vary in size according to power output, weather, or other conditions. In one or more implementations, the service area can for instance be defined by a circle within a given radius of one of set of base stations 110, or by other zones around one of set of base stations 110. The radius can vary based on, for example, the power output of the service broadcast of set of base stations 110, the antenna size or height of set of base stations 110, and/or other factors. Communication service between mobile device 105 and set of base stations 110 can be established if mobile device 105 is located within the service area. Set of base stations 110 can be configured to communicate location data 112 with mobile device 105. Location data 112 can comprise latitude and longitude coordinates, or any other data defining or relating to location.

Content provider 120 may be an internet service provider (ISP) or other provider of digital content. Content provider 120 may operate a content server 135 for providing access to digital content 140 stored in computer readable media. Wireless services provider 125 may be linked to content provider 120 through any appropriate communications link 324, such as a WAP gateway, a socket connection, etc. In an implementation, wireless services provider 125 may retrieve digital content 140 from content server 135 over a communications link and provide digital content 140 to mobile devices 105 over wireless interface 115. However, it is to be understood that the present disclosure is not limited to such an arrangement, and that mobile device 105 may obtain digital content 140 by other mechanisms. For example, mobile device 105 may be linked to content provider 120 by a land line and, in some implementations, some or all of digital content 140 may be stored in a memory of mobile device 105.

Digital content 140 provided by content provider 120 may be any type of content, such as geographic data tags, data associated with geographic locations and/or regions, etc., suitable for access using mobile device 105. Digital content 140 provided by content provider 120 may also be any type of content specific to users of mobile devices 105, such as maps or lists of the users' past and present geographic locations, geographic locations similar to the users' present geographic locations, and geographic locations of the users' friends and other shared data accessible to mobile device 105.

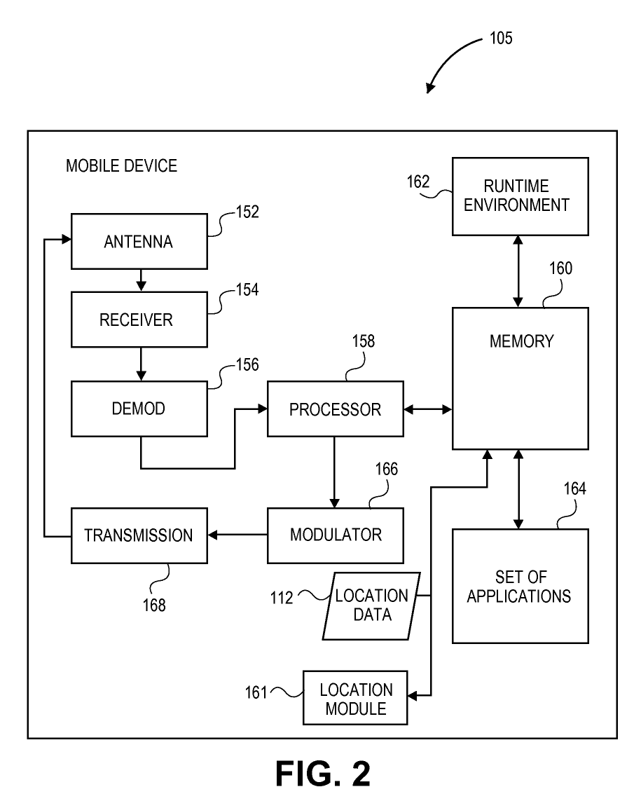

FIG. 2 illustrates an exemplary hardware configuration of a mobile device 105, consistent with one or more implementations. Mobile device 105 can include at least one antenna 152 (e.g., a transmission receiver or group of such receivers comprising an input interface) that receives a signal (e.g., pertaining to a mobile call initiation or other handshake, a handshake response, a mobile application data transfer, a data event, data event response, handshake termination, and so on) and a receiver 154, which performs actions (e.g., filters, amplifies, down-converts, etc.) on the received signal. Antenna 152 can for example transmit or receive a response to a handshake request, data event request, or the like. Antenna 152 and receiver 154 can also be coupled with a demodulator 156 that can demodulate received signals and provide them to a processor 158 for processing. Mobile device 105 can additionally include memory 160 that is operatively coupled to processor 158 and that can store data to be transmitted, received, and the like. A location module 161 can calculate and/or estimate location data 112 in accordance with one or more implementations described herein. Location module 161 can be configured to communicate location data 112 with memory 160.

Processor 158 can analyze information received by antenna 152 and/or a user input interface of mobile device 105 (not depicted), and/or generate information for transmission by a transmitter 168 via a modulator 166. Additionally, processor 158 can control and/or reference one or more resources or components (e.g., 156, 162, 164, 166, or 168) of mobile device 105. Additionally, processor 158 can execute a runtime environment 162, such as the BREW platform available from QUALCOMM Incorporated, as well as one or more set of applications 164 or other software, modules, applications, logic, code, or the like.

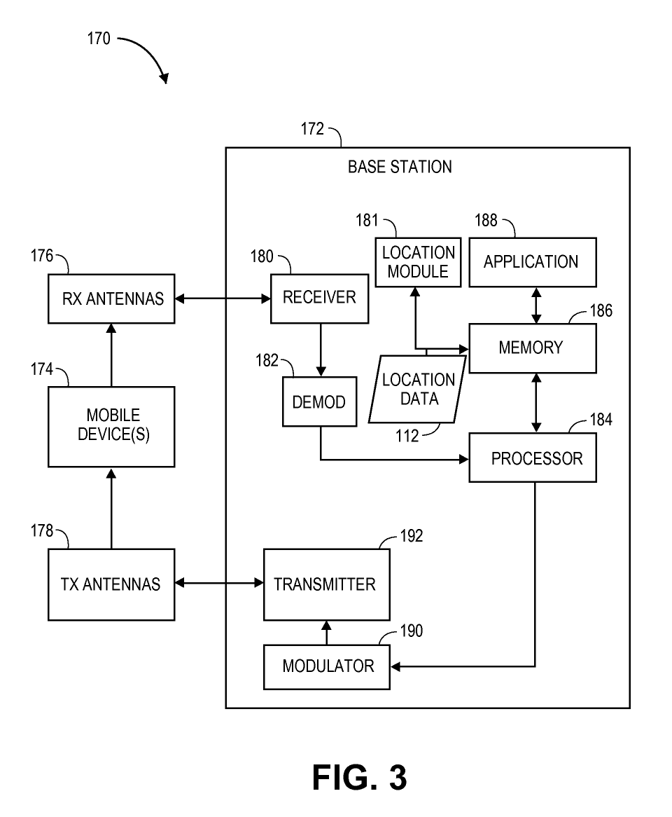

FIG. 3 illustrates an exemplary hardware configuration of a system 170 including a base station 172 according to various implementations. System 170 comprises base station 172 (e.g., access point, cell tower, etc.) with a receiver 180 that receives signal(s) from one or more mobile devices 174 through a plurality of receive antennas 176, and a transmitter 192 that transmits to the one or more mobile devices 174 through a transmit antenna 178. Receiver 180 can receive information from receive antennas 176 and be operatively associated with a demodulator 182 that demodulates received information.

A processor 184 can analyze demodulated signals provided by demodulator 182. The processor 184 further couples to a modulator 190 and a memory 186 that can store one or more application 188 that can execute, support, facilitate and/or participate in communication activities as described herein. A location module 181 can calculate and/or estimate location data 112 in accordance with one or more implementations described herein. Location module 181 can be configured to communicate location data 112 with memory 186.

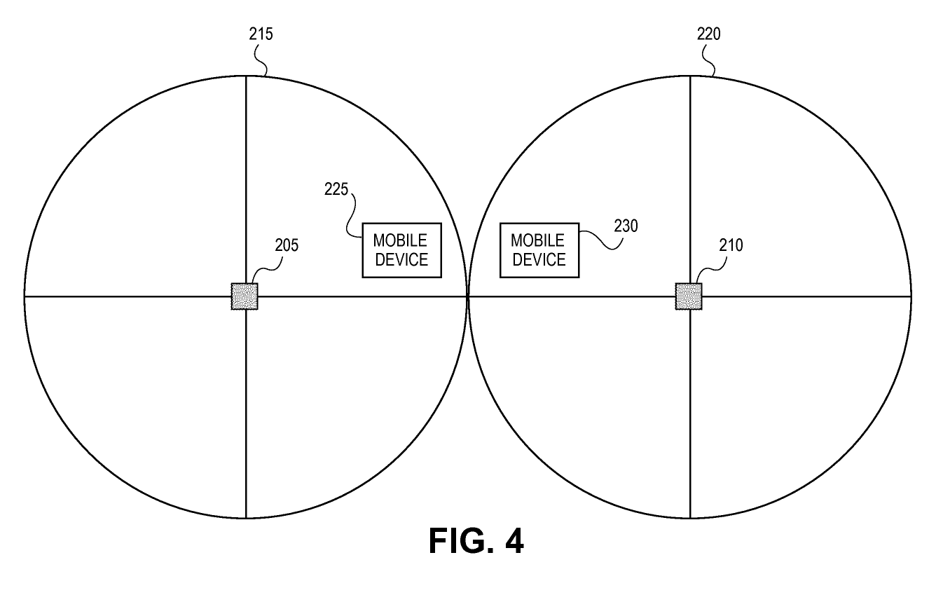

FIG. 4 is a diagram illustrating an exemplary physical, geographical, or functional relationship between service areas, according to one example. Further, FIG. 4 details an overview of a set of mobile devices located in a set of services areas and in service connection with a set of base stations in accordance with one or more implementations. FIG. 4 depicts a first base station 205 and a second base station 210. First base station 205 has a corresponding first service area 215 which defines an area in which a mobile device located within the area can receive a service connection. Similarly, second base station 210 has a corresponding second service area 220 which defines an area in which a mobile device located within the area can receive a service connection. First base station 205 and second base station 210 can be located in the center region of first service area 215 and second service area 220, respectively.

As shown in FIG. 4, a first mobile device 225 can be located within first service area 215 and can, accordingly, receive a service connection from first base station 205. Similarly, as shown in FIG. 4, a second mobile device 230 is located within second service area 220 and can, accordingly, receive a service connection from second base station 210.

If first mobile device 225 leaves first service area 215 and enters second service area 220, a handoff event can occur. The handoff event can consist of a series of processing stages which result in the transfer of the service connection of first mobile device 225 from first base station 205 to second base station 210. A handoff event can occur in instances when first or second mobile device 225 or 230 is moving, as in cases where the user is, for example, driving a car, walking, riding a bike, or otherwise roaming in some way. It may be noted that, in one or more implementations, first service area 215 can overlap with second service area 220. Further, first or second mobile device 225 or 230 can experience a handoff event from first service area 215 to second service area 220, or vice-versa, at any time when first or second mobile device 225 or 230 transitions between first service area 215 and second service area 220.

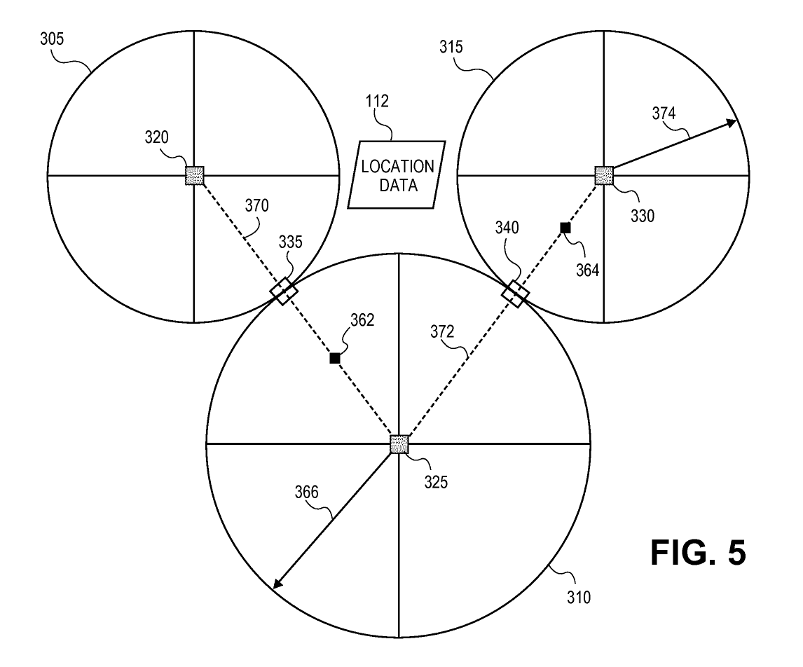

FIG. 5 is a diagram illustrating an implementation of an estimation of an approximate location of a mobile device. FIG. 5 illustrates a network configuration including a base station A 320, a base station B 325, and a base station C 330. Base station A 320 can support a corresponding service area A 305, base station B 325 can support a corresponding service area B 310, and base station C 330 can support a corresponding service area C 315. It will be understood that location data 112 can comprise any location or position data associated with or stored by the mobile device or one of base stations A, B, or C 320, 325, or 330. Further, location data 112 can comprise any calculations, estimations, or determinations of connecting lines, midpoints, previous locations, dither zones, iterations, or any other data related to the implementations described herein.

When the mobile device is located within one of service areas A, B, or C 305, 310, or 315, the mobile device can be configured to connect to one of corresponding base stations A, B, or C 320, 325, or 330. Base stations A, B, or C 320, 325, or 330 can store their own location data 112, which can comprise latitude and longitude coordinates, and/or any other type of location data 112. Base stations A, B, or C 320, 325, or 330 can further be aware when the mobile device is connected. Further, when the mobile device is located within one of service areas A, B, or C 305, 310, or 315, the mobile device can be configured to receive and store electronic data from corresponding base stations A, B, or C 320, 325, or 330 reflecting location data 112 of corresponding base stations A, B, or C 320, 325, or 330. For example, if the mobile device is located in service area A, the mobile device can receive and store location data 112 from base station A 320, comprising, for example, the latitude and longitude location of base station A 320.

When the mobile device leaves one of service areas A, B, or C 305, 310, or 315 and enters another one of service areas A, B, or C 305, 310, 315, a handoff event can occur. For example, if the mobile device leaves its location in service area A 305 and enters service area B 310, the service connection of the mobile device is handed off to service area B 3 10. Consequently, the service connection between the mobile device and base station A 320 will terminate, and the mobile device will enter into a service connection with base station B 325. According to one or more implementations, when the mobile device leaves one of service areas A, B, or C 305, 310, or 315 and enters another one of service areas A, B, or C 305, 310, or 315, the mobile device can be configured to receive and store location data 112 from the corresponding one of base stations A, B, or C, 305, 310, or 315 comprising location data 112 for corresponding one of base stations A, B, or C 320, 325, or 330. For example, if the mobile device leaves service area A 305 and enters service area B 310, the mobile device can receive and store location data 112 comprising the latitude and longitude location of base station B 325.

The mobile device can be configured to store location data 112 of its previous one of base stations A, B, or C 305, 315, or 315, along with detecting, receiving, or recording the fact that a handoff event has occurred, as well as location data 112 associated with the new one of base stations A, B, or C 320, 325, or 330. For example, if the mobile device moves from service area A 305 to service area B 310, the mobile device can be configured to be aware that it is currently in service connection with base station B 325, receive location data 112 comprising the latitude and longitude location of base station B 325, be aware that the mobile device was previously in service connection with base station A 320, and receive location data 112 comprising the latitude and longitude location of base station A 320. In one or more implementations, the mobile device can be configured to store location data 112 comprising the latitude and longitude location of a number or all of base stations A, B, or C 320, 325, or 330 to which it has been connected over time. Conversely, the current one of base stations A, B, or C 320, 325, or 330 can be configured to store location data 112 comprising the location of base stations A, B, or C, 305, 310, or 315 to which the mobile device was previously connected to, as well as location data 112 comprising the locations of any and all surrounding base stations A, B, or C 320, 325, or 330.

When a handoff event takes place related to the mobile device, in one or more implementations, the mobile device can be configured to compute an estimated location of the mobile device based on a relationship between the location of one of base stations A, B, or C 320, 325, or 330 to which the mobile device is currently connected and the location of one of base stations A, B, or C 320, 325, or 330 to which the mobile device was previously connected. In one or more implementations, the mobile device can be configured to calculate a projected connecting line between the location of the current one of base stations A, B, or C 320, 325, or 330 and the location of the previous one of base stations A, B, or C 320, 325, or 330. For example, if the mobile device moves from service area A 305 to service area B 310, then the mobile device can be configured to compute a connecting line 370 between base station A 320 and base station B 325. Similarly, if the mobile device moves from service area B 310 to service area C 315, then the mobile device can be configured to compute a connecting line 372 between base station B 325 and base station C 330.

Further, the mobile device can be configured to compute a midpoint on one of connecting lines 370, 372 between the current one of base stations A, B, or C 320, 325, or 330 and the previous one of base stations A, B, or C 320, 325, or 330. For example, if the mobile device moves from service area A 305 to service area B 310, then the mobile device can be configured to compute a midpoint 335 between base station A 320 and base station B 325. Similarly, if the mobile device moves from service area B 310 to service area C 315, then the mobile device can be configured to compute a midpoint 340 between base station B 325 and base station C 330.

It will be appreciated that when the mobile device leaves one of service areas A, B, or C 305, 310, or 315 and enters another one of service areas A, B, or C 305, 310, or 315, according to one or more implementations, the location of the mobile device can be approximated to equal to, or be derived from, one of midpoints 335, or 340 between corresponding base stations A, B, or C 320, 325, or 330 of corresponding service areas A, B, or C 305, 310, or 315. That is, because the mobile device is known to be entering one of service areas A, B, or C 305, 310, or 315 from another one of service areas A, B, or C 305, 310, or 315, where the locations of corresponding base stations A, B, or C, 320, 325, or 330 of said service areas A, B, or C 305, 310,or 315, midpoints 335 or 340 between the locations of corresponding base stations A, B, or C, 320, 325, or 330 is the position at which the mobile device is most likely to be found. For example, if the mobile device leaves service area A 305 and enters service area B 310, and its service is subsequently handed off from base station A 320 to base station B 325, then the mobile device can be configured to assign midpoint 335 as the approximate location of the mobile device. The locations of midpoints 335 or 340 can further be computed to be approximately equivalent to the point where corresponding service areas A, B, or C 305, 310, or 315 intersect. The accuracy of the estimated location of the mobile device can be improved over the case of knowing only the location of one of base stations A, B, or C 320, 325, or 330 to which the mobile device is currently registered, since that data can only locate the mobile device within the overall corresponding service areas A, B, or C 305, 310, or 315, as opposed to the midpoint connection, quadrant, or zone in the current one of service areas A, B, or C 305, 310, or 315 closest to one of service areas A, B, or C 305, 310, or 315 from which the mobile device departed.

In one or more implementations, the mobile device can be configured to register the size of each of corresponding service areas A, B, or C 305, 310, or 315. As shown in FIG. 5, each of corresponding service areas A, B, or C 305, 310, or 315 can be a generally circle shape. Consequently, the mobile device can be configured to register the service radius of the corresponding one of base stations A, B, or C 320, 325, or 330. For example, as shown in FIG. 5, service area B 310 has a corresponding service radius B 366, and service area C 315 has a corresponding service radius C 374. In one or more implementations, the size of each of service areas A, B, or C 305, 310, or 315 can vary based on broadcast strength, weather, or any other conditions.

In one or more implementations, the midpoint can be located along connecting lines 370 or 372 at a distance away from base stations A, B, or C 320, 325, or 330 equal to service radii B or C 366 or 374. For example, as shown in FIG. 5, midpoint 335 can be calculated to be located along connecting line 370 at a distance away from base station B 325 equal to service radius B 366. In one or more implementations, if one of base stations A, B, or C 320, 325, or 330 is not aware or cannot obtain the size of its corresponding one of service areas A, B, or C 305, 310, or 315, a default size can be assumed. For example, if one of base stations A, B, or C 320, 325, or 330 is in an urban area, the default size can be small, as many exemplary base stations typically service relatively compact urban areas. Similarly, if one of base stations A, B, or C 320, 325, or 330 is in a rural area, the default size can be large, as fewer exemplary base stations typically service rural areas.

Further, the mobile device can be configured to calculate a sector center point along connecting lines 370 or 372 and located halfway between midpoints 335 or 340 and base stations A, B, or C 320, 325, or 330. For example, the mobile device can be configured to calculate a sector center B 362 located halfway between midpoint 335 and base station B 325. Similarly, the mobile device can be configured to calculate a sector center C 364 located halfway between midpoint 340 and base station C 330. In one or more implementations, the mobile device can be configured to assign as sector centers B or C 362 or 364 a point on connecting lines 370 or 372 and at a distance equal to a certain percentage of service radii B or C 366 or 374 of the corresponding one of base stations A, B, or C 320, 325, or 330 such as, for example, 60%, or other amounts.

As explained herein, it should be appreciated that base stations A, B, or C 320, 325, or 330 can be configured to be aware that the mobile device is connected to base stations A, B, or C 320, 325, or 330, as well as be aware that a handoff event took place with a previous base station. Using location data 112 of current one of base stations A, B, or C 320, 325, or 330 along with location data 112 of previous one of base stations A, B, or C 320, 325, or 330, base stations A, B, or C 320, 325, or 330 can calculate the approximate location of the mobile device in accordance with one or more of the present implementations. If base stations A, B, or C 320, 325, or 330 do not have information about the previous one of base stations A, B, C 320, 325, or 330, base stations A, B, or C 320, 325, 330 can use the location of another previous one of base stations A, B, or C 320, 325, or 330 to which the mobile device was in service connection to approximate the location of the mobile device. Base stations A, B, or C 320, 325, or 330 can further be configured to store the locations and sector centers B or C 362 or 364 of any and all surrounding base stations A, B, or C 320, 325, or 330 and service areas A, B, or C 305, 310, or 315, respectively.

It should further be appreciated that the mobile device can execute an application, service, and/or the like to determine its location within the corresponding one of service areas A, B, or C 305, 310, or 315. In this regard, when the mobile device executes the application, service, and/or the like, the mobile device can communicate with corresponding one of base stations A, B, or C 320, 325, or 330. Further, the mobile device can store the location of one of base stations A, B, or C 320, 325, or 330 that the mobile device is in service connection with, as well the fact that a handoff event occurred, along with the location of one of base stations A, B, or C 320, 325, or 330 to which the mobile device was previously connected. For example, the mobile device can determine the location of one of base stations A, B, or C 320, 325, or 330 to which it is connected by utilizing a known embedded API such as, for example, the aforementioned “GetSectorInfo( )” as used by, for example, BREW® platform of QUALCOMM Incorporated, which returns the latitude and longitude coordinates of one of base stations A, B, or C 320, 325, or 330 to the calling application.

Similar to base stations A, B, or C 320, 325, or 330, if the mobile device does not have information about a handoff event or previous one of base stations A, B, or C 320, 325, or 330, the mobile device can approximate its location using a random or specific point within the corresponding one of service areas A, B, or C 305, 310, or 315 such as, for example, the location of the current one of base stations A, B, or C 320, 325, or 330. The mobile device can further be configured to store the locations and sector centers B or C 362 or 364 of any and all surrounding base stations A, B, or C 320, 325, or 330 and service areas A, B, C 305, 310, 315, respectively.

In one or more implementations, the approximate location of the mobile device can be iterated for greater accuracy when the mobile device determines that the mobile device is located in the same one of service areas A, B, or C 305, 310, or 315 as it was during the preceding determination. For example, if after the mobile device moves from service area B 310 to service area C 315 and midpoint 340 is determined, and it is subsequently determined that the mobile device is still connected to base station C 330 and hence within service area C 315, then the approximate location of the mobile device can be iterated. The iteration can be performed by moving the approximate location of the mobile device from midpoint 340 closer to sector center C 364. Subsequent iterations can incrementally move the approximate location further towards the corresponding one of sector centers B or C, 362 or 364 of the current one of service areas A, B, or C 305, 310, or 315. For example, accuracy can be improved in this regard because if the mobile device is located in the same one of service areas A, B, or C 305, 310, or 315 after subsequent calculations, then it has a greater chance of being closer to the corresponding one of sector centers B or C 362 or 364 of the corresponding one of service areas A, B, or C 305, 310, or 315 than towards the outer perimeter of the corresponding one of service areas A, B, or C 305, 310, or 315.

In one or more implementations, the mobile device can estimate the velocity of the user of the mobile device based on a rate of change of various handoff events. For example, if the mobile device determines that it is located in the same one of service areas 305, 310, or 315 as it was during the preceding determination, then the mobile device can, for example, estimate its velocity dependent on a time variable and the area of the corresponding one of service areas A, B, or C 305, 310, or 315. Further, for example, if the mobile device determines that it transfers service to multiple ones of service areas A, B, or C 305, 310, or 315 during subsequent determinations, then the mobile device can, for example, estimate its velocity dependent on a time variable and the area of the multiple ones of service areas A, B, or C 305, 310, or 315.

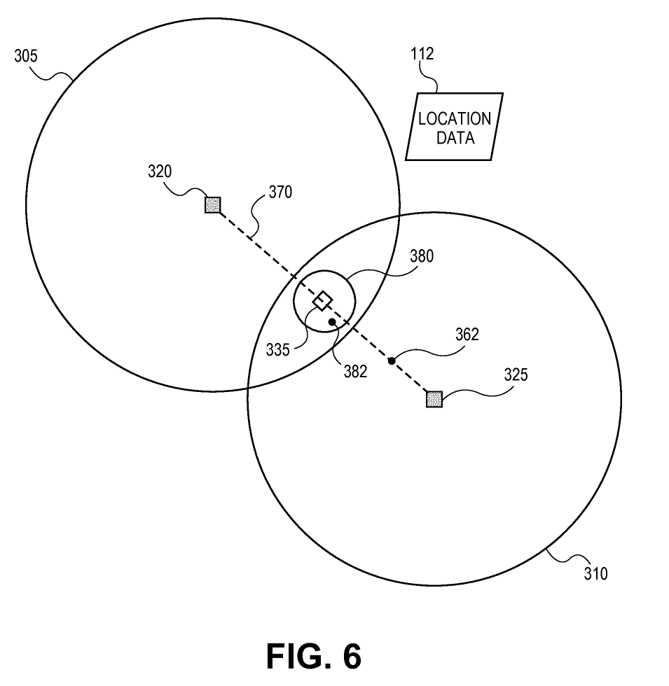

FIG. 6 is a diagram illustrating an implementation of an estimation of an approximate location of a mobile device, according to one aspect. FIG. 6 includes service area A 305 and service area B 310 as shown in FIG. 5. As shown in FIG. 6, service area A 305 and service area B 310 overlap slightly. FIG. 6 further includes base station A 320 and base station B 325 as shown in FIG. 5. It may be understood that location data 112 can comprise any location or position data associated with the mobile device or one of base stations 320, 325. Further, location data 112 can comprise any calculations, estimations, or determinations of exemplary connecting lines, midpoints, dither zones, previous locations, iterations, or any other data relevant to the implementations described herein.

In accordance with an implementation as explained herein, the mobile device and/or base stations A or B 320 or 325 can calculate the approximate location of the mobile device by using the locations of the current one of base stations A or B 320 or 325 and the previous one of base stations A or B 320 or 325 preceding a handoff event. In one or more implementations, the mobile device and/or base stations A or B 320 or 325 can calculate a dither zone surrounding the approximate location. The dither zone can have a set radius or area, or can have a radius or area size in proportion to the size of corresponding service areas A or B 305 or 310. For example, the size of the dither zone can be 100 m² or can have a radius of, for a example, 10% of the radius of corresponding service areas A or B 305 or 310.

As shown in FIG. 6, a dither zone 380 can have its center point along connecting line 370 at midpoint 335. If the mobile device enters a handoff event from base station A 320 to base station B 325, then the mobile device and/or base station B 325 can be configured to randomly generate a location 382 within dither zone 380. Randomly generated location 382 within dither zone 380 can be used as an approximation of the location of the mobile device instead of midpoint 335, as explained herein. The use of randomly generated location 382 within dither zone 380 can produce greater accuracy than using midpoint 335 when estimating the location of the mobile device. In one or more implementations, the use of randomly generated location 382 within dither zone 380 can improve accuracy for example when adjacent ones of service areas A or B 320 or 325 overlap.

In one or more implementations, as explained herein, when subsequent iterations of the location calculation indicate that the mobile device remains in a given one of service areas A or B 320 or 325, then the center point of dither zone 380 can be iterated closer to sector center B 362 of service area B 325. For example, in FIG. 6, if subsequent iterations of the calculation indicate that the mobile device is still connected to base station B 325, then the mobile device and/or base station B 325 can iterate the center of dither zone 380 along connecting line 370 and closer to sector center B 362. Further, the mobile device and/or base station B 325 can then randomly generate location 382 within iterated dither zone 380 and assigned randomly generated location 382 as the approximate location of the mobile device.

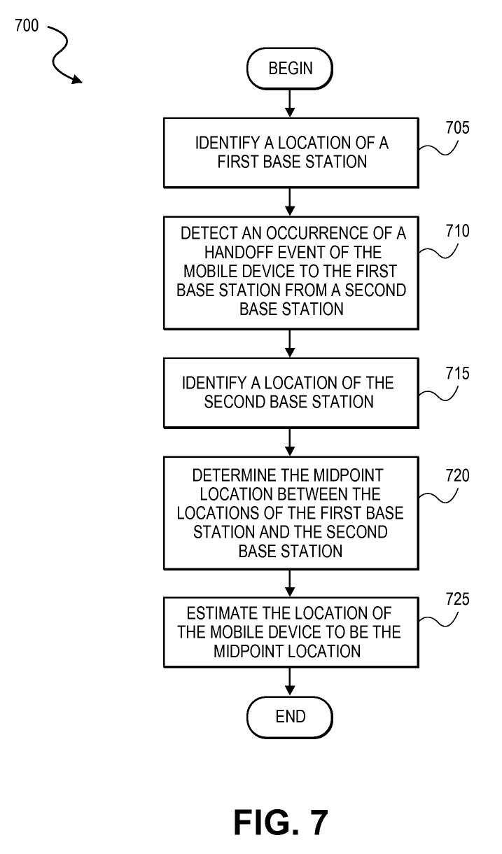

FIG. 7 is a flow diagram illustrating a process 700 of estimating the location of a mobile device. Process 700 can be performed by a first base station to which the mobile device is registered or connected. In one or more aspects process 700 can be performed by a separate server, or other entity or logic in wireless network 100 or other networks that can receive base station location and handoff event data from a base station or another component. It should be apparent to those of ordinary skill in the art that the diagram depicted in FIG. 7 represents a generalized illustration and that other processing may be added or existing processing can be removed or modified.

Process 700 begins when the first base station identifies its location, in 705. The first base station detects an occurrence of a handoff event of the mobile device to the first base station from a second base station, in 710. For example, the mobile device can terminate service connection with the second base station and enter into service connection with the first base station. The first base station identifies a location of the second base station, in 715. The first base station can calculate a connecting line between the locations of the first base station and the second base station. The first base station determines the midpoint location between the locations of the first base station and the second base station and along the connecting line, in 720. The first base station estimates the location of the mobile device to be the midpoint location, in 725.

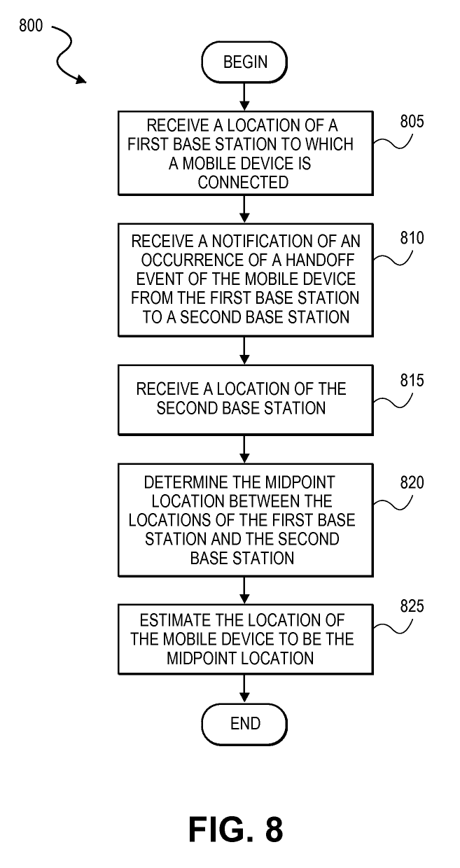

FIG. 8 is a flow diagram illustrating a process 800 of estimating the location of a mobile device, according to one aspect. Process 800 can be performed by a mobile device connected to a first base station. It should be apparent to those of ordinary skill in the art that the diagram depicted in FIG. 8 represents a generalized illustration and that other processing may be added or existing processing can be removed or modified.

Process 800 begins when a mobile device receives a location of the first base station to which the mobile device is connected, in 805. The mobile device receives a notification of an occurrence of a handoff event of the mobile device from the first base station to a second base station, in 810. For example, the mobile device can terminate service connection with the first base station and enter into service connection with the second base station. The mobile device receives a location of the second base station, in 815. The mobile device can calculate a connecting line between the locations of the first base station and the second base station. The mobile device determines the midpoint location between the locations of the first base station and the second base station and along the connecting line, in 820. The mobile device estimates the location of the mobile device to be the midpoint location, in 825.

In one or more implementations, the approximate location of the mobile device that either the base station or the actual mobile device calculates can be used as an input into a GPS search device. The approximate location can be sent to, for example, a GPS device, or can be utilized in a GPS service on the mobile device. Upon startup, a GPS device must acquire satellite signals and navigation data, and calculate a position solution in a process known as time to first fix. This process is time consuming and can delay the GPS device in determining its location. However, if the GPS device receives its approximate location in accordance with the present implementation, the GPS device need not compute through all satellite positions that it normally would relay though upon startup. Instead, the GPS device would only need to search for a limited number of GPS satellites to determine its GPS location. This can reduce startup and search time, and be useful, for example, upon the startup of a GPS device or if a GPS device loses satellite service, thus improving the time to first fix.

In one or more implementations, the present method can be calculated adaptively based on the velocity of the moving mobile device. This implementation requires that either the base station or the mobile device be aware of this velocity, for example using sampling of the position of the mobile device, or that the mobile device have velocity sensors available. In this implementation, the approximate location can be estimated to be located at a variable distance along the connecting line, and not at a set midpoint. For example, if it is known that the mobile device is roaming at a comparatively slow speed such as, for example, 10 mph, then the approximate location can be estimated at a location closer to the midpoint and further from the base station. For further example, if it is known that the mobile device is roaming at a comparatively fast speed such as, for example, 70 mph, then the approximate location can be estimated at a location further from the midpoint and closer to the base station. In one or more aspects, the velocity of the mobile device can be calculated based on the elapsed time between two or more consecutive handoff events, or based on other time points.

The foregoing description is illustrative, and variations in configuration and implementation may occur to persons skilled in the art. For instance, the various illustrative logics, logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the elements described herein can also be included within the scope of computer-readable media.

The processing of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM , etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

While the foregoing disclosure discusses illustrative aspects and/or implementations, it should be noted that various changes and modifications could be made herein without departing from the scope of the described aspects and/or implementations, as defined by the appended claims. Furthermore, although elements of the described aspects and/or implementations may be described or claimed in the singular, the plural is contemplated unless limitation to the singular is explicitly stated. Additionally, all or a portion of any aspect and/or implementation may be utilized with all or a portion of any other aspect and/or implementations, unless stated otherwise.

What is claimed is:

1. A method of estimating a location of a mobile device, comprising:
identifying a location of a first base station;
detecting an occurrence of a handoff event transferring a service connection of the mobile device from the first base station to a second base station;
identifying a location of the second base station; and
estimating the location of the mobile device based on the detected handoff event and the locations of the first base station and the second base station.

2. The method of claim 1, wherein the estimated location of the mobile device is on a line connecting the location of the first base station and the location of the second base station.

3. The method of claim 2, wherein the estimated location of the mobile device comprises a midpoint of the line.

4. The method of claim 1, wherein the estimating of the location of the mobile device is further based on a velocity of the mobile device.

5. The method of claim 1, further comprising:
updating the estimated location of the mobile device based on a randomly generated point within a dither zone surrounding the estimated location of the mobile device.

6. The method of claim 1, further comprising:
iterating the estimation of the location of the mobile device while the mobile device remains in service with the first base station.

7. The method of claim 1, further comprising:
inputting the location of the mobile device to a GPS-enabled device.

8. A system for estimating a location of a mobile device, comprising:
a server being configured to:
identify a location of a first base station;
detect an occurrence of a handoff event transferring a service connection of the mobile device to the first base station from a second base station;
identify a location of the second base station; and
estimate the location of the mobile device based on the detected handoff event and the locations of the first base station and the second base station.

9. The system of claim 8, wherein the estimated location of the mobile device is on a line connecting the location of the first base station and the location of the second base station.

10. The system of claim 8, wherein the estimated location of the mobile device is further estimated based on a velocity of the mobile device.

11. The system of claim 8, wherein the server is further configured to update the estimated location of the mobile device based on a randomly generated point within a dither zone surrounding the estimated location of the mobile device.

12. The system of claim 8, wherein the server is further configured to iterate the estimated location of the mobile device while the mobile device remains in service with the first base station.

13. The system of claim 8, wherein the server is further configured to input the location of the mobile device to a GPS-enabled device.

14. A system for estimating a location of a mobile device, comprising:
means for serving data to a mobile device, the means for serving being configured to:
identify a location of a first base station;
detect an occurrence of a handoff event transferring a service connection of the mobile device from the first base station to a second base station;
identify a location of the second base station; and
estimate the location of the mobile device based on the detected handoff event and the locations of the first base station and the second base station.

15. The system of claim 14, wherein the estimated location of the mobile device is on a line connecting the location of the first base station and the location of the second base station.

16. The system of claim 14, wherein the estimated location of the mobile device is further estimated based on a velocity of the mobile device.

17. The system of claim 14, wherein the server is further configured to update the estimated location of the mobile device based on a randomly generated point within a dither zone surrounding the estimated location of the mobile device.

18. The system of claim 14, wherein the server is further configured to iterate the estimated location of the mobile device while the mobile device remains in service with the first base station.

19. The system of claim 14, wherein the server is further configured to input the location of the mobile device to a GPS-enabled device.

20. A computer program product, comprising:
a computer-readable medium comprising:
at least one instruction for causing a computer to identify a location of a first base station;
at least one instruction for causing a computer to detect an occurrence of a handoff event transferring a service connection of the mobile device from the first base station to a second base station;
at least one instruction for causing a computer to identify a location of the second base station; and
at least one instruction for causing a computer to estimate a location of the mobile device based on the detected handoff event and the locations of the first base station and the second base station.

21. The computer program product of claim 20, wherein the estimated location of the mobile device is on a line connecting the location of the first base station and the location of the second base station.

22. The computer program product of claim 20, wherein the estimated location of the mobile device is further estimated based on a velocity of the mobile device.

23. The computer program product of claim 20, wherein the computer-readable medium further comprises at least one instruction for causing a computer to update the estimated location of the mobile device based on a randomly generated point within a dither zone surrounding the estimated location of the mobile device.

24. The computer program product of claim 20, wherein the computer-readable medium further comprises at least one instruction for causing a computer to iterate the estimated location of the mobile device while the mobile device remains in service with the first base station.

25. The computer program product of claim 20, wherein the computer-readable medium further comprises at least one instruction for causing a computer to input the location of the mobile device to a GPS-enabled device.

26. A method of estimating a location of a mobile device, comprising:
receiving a location of a first base station to which the mobile device is registered;
receiving a notification of an occurrence of a handoff event transferring a service connection of the mobile device from the first base station to a second base station;
receiving a location of the second base station; and
estimating, in the mobile device, the location of the mobile device based on the detected handoff event and the locations of the first base station and the second base station.

27. The method of claim 26, wherein the estimated location of the mobile device is on a line connecting the location of the first base station and the location of the second base station.

28. The method of claim 27, wherein the estimated location of the mobile device comprises a midpoint of the line.

29. The method of claim 26, wherein the estimating of the location of the mobile device is further based on a velocity of the mobile device.

30. The method of claim 26, further comprising:
updating the estimated location of the mobile device based on a randomly generated point within a dither zone surrounding the estimated location of the mobile device.

31. The method of claim 26, further comprising:
iterating the estimated location of the mobile device while the mobile device remains in service with the second base station.

32. The method of claim 26, further comprising:
inputting the location of the mobile device to a GPS-enabled device.

33. A mobile device, comprising:
a wireless interface; and
a processor, communicating with the wireless interface, the processor being configured to:
receive a location of a first base station to which the mobile device is registered;
receive a notification of an occurrence of a handoff event transferring a service connection of the mobile device from the first base station to a second base station;
receive a location of the second base station; and
estimating, in the mobile device, a location of the mobile device based on the detected handoff event and the locations of the first base station and the second base station.

34. The device of claim 33, wherein the estimated location of the mobile device is on a line connecting the location of the first base station and the location of the second base station.

35. The device of claim 34, wherein the estimated location of the mobile device comprises a midpoint of the line.

36. The device of claim 33, wherein the estimated location of the mobile device is further estimated based on a velocity of the mobile device.

37. The device of claim 33, wherein the processor is further configured to update the estimated location of the mobile device based on a randomly generated point within a dither zone surrounding the estimated location of the mobile device.

38. The device of claim 33, wherein the processor is further configured to iterate the estimated location of the mobile device while the mobile device remains in service with the second base station.

39. The device of claim 33, wherein the processor is further configured to input the location of the mobile device to a GPS-enabled device.

40. A system for estimating a location of a mobile device, comprising:
means for providing a wireless interface; and
means for processing data from the second base station, communicating with the means for providing a wireless interface, the processor being configured to:
receive a location of a first base station to which the mobile device is registered;
receive a notification of an occurrence of a handoff event transferring a service connection of the mobile device from the first base station to a second base station;
receive a location of the second base station; and
estimating, in the mobile device, the location of the mobile device based on the detected handoff event and the locations of the first base station and the second base station.

41. The system of claim 40, wherein the estimated location of the mobile device is on a line connecting the location of the first base station and the location of the second base station.

42. The system of claim 40, wherein the estimated location of the mobile device is further estimated based on a velocity of the mobile device.

43. The system of claim 40, wherein the processor is further configured to update the estimated location of the mobile device based on a randomly generated point within a dither zone surrounding the estimated location of the mobile device.

44. The system of claim 40, wherein the processor is further configured to iterate the estimated location of the mobile device while the mobile device remains in service with the second base station.

45. The system of claim 40, wherein the processor is further configured to input the location of the mobile device to a GPS-enabled device.

46. A computer program product, comprising:
a computer-readable medium comprising:
at least one instruction for causing a computer to receive a location of a first base station to which a mobile device is connected;
at least one instruction for causing a computer to receive a notification of an occurrence of a handoff event transferring a service connection of the mobile device from the first base station to a second base station;
at least one instruction for causing a computer to receive a location of the second base station; and
at least one instruction for causing a computer to estimate a location of the mobile device based on the detected handoff event and the locations of the first base station and the second base station.

47. The computer program product of claim 46, wherein the estimated location of the mobile device is on a line connecting the location of the first base station and the location of the second base station.

48. The computer program product of claim 46, wherein the estimated location of the mobile device is further estimated based on a velocity of the mobile device.

49. The computer program product of claim 46, wherein the computer-readable medium further comprises at least one instruction for causing a computer to update the estimated location of the mobile device based on a randomly generated point within a dither zone surrounding the estimated location of the mobile device.

50. The computer program product of claim 46, wherein the computer-readable medium further comprises at least one instruction for causing a computer to iterate the estimated location of the mobile device while the mobile device remains in service with the second base station.
